(19) United States
(12) Patent Application Publication
(10) Pub. No.: US 2003/0118745 A1
(43) Pub. Date: Jun. 26, 2003

(54) Method for preparing the surface of synthetic cork material for printing

(76) Inventors: Anthony Vanlandeghem, Oudenaarde (BE); Johan Palmers, Amougies (BE); Ralf Greger, Oudenaarde (BE)

Correspondence Address: James C. Wray, Suite 300, 1493 Chain Bridge Road, McLean, VA, 22101, US

(21) Appl. No.: 10/025,549

(22) Filed: Dec. 26, 2001

(51) Int. Cl. H05H 1/24

(52) U.S. Cl. 427/535

(57) ABSTRACT

Method for preparing the surface of objects made of cork material for printing, in which the objects are subjected to at least one low pressure plasma treatment step. The cork material can be selected from natural cork and synthetic cork, in particular thermoplastic elastomer and/or styrene bloc copolymer. The low pressure plasma comprises a gas or gas mixture selected from O₂, N₂, NOₓ, NH₃, Ar, He, Ne, CO, CO₂, SO₂, SO₃, CF₄ and SF₆, at a pressure from 0.01 to 5 mbar. A power supply operating in the KHz, MHz or GHz range is used. The plasma treatment step(s) can be carried out several hours or days before printing the objects made of cork material. The method is applied so as to reach a surface dyne level of at least 50 dynes. The objects can be tumble treated as bulk goods in batches of at least 1000 pieces/batch.

### BACKGROUND OF THE INVENTION

The present invention relates to closures for liquid containers, such as stoppers for wine bottles, and more particularly to a method for improving the printability of such closures.

Applying print on stoppers for wine bottles has always constituted a problem, already with natural cork material, but even more with synthetic cork material.

Natural cork has commonly been used for making stopper type bottle closures.

There is however a tendency, in this type of application, to replace natural cork material by synthetic cork material, as disclosed, for instance, in U.S. Pat. No. 6,127,437, the disclosure of which is thus introduced herein by reference.

There are significant disadvantages to using natural cork in the manufacture and marketing of bottle closures. Natural cork has variable properties with respect to color, drying, shrinkage or expansion, crumbling, sticking to containers and seal formation. These features are generally unsatisfactory in terms of production and consumer costs as well as product performance. In the case of wine closures, cork may also impart an odor to the product, causing it to be rejected by consumers. In addition, nearly 10% of bottled wine is discarded because of unpredictable contamination by mold from natural cork. Further, the use of cork for producing bottle closures is becoming increasingly expensive as the supply of trees from which cork is obtained rapidly diminishes.

Numerous attempts have been made to develop alternatives to natural cork bottle stoppers.

Among these, screw top closures for wine containers have been found largely unsuitable because they do not provide the appearance, ceremony or romance that surrounds traditional cork wine closures. A number of synthetic cork closures have also been developed. In particular, recent efforts to develop closures from injection molded foam thermoplastics have encountered numerous pitfalls, particularly in terms of production costs, product performance, and consumer acceptance.

Some of these closures have exhibited a tendency to noticeably taint the product and/or offer low resistance to oxygen permeation into the container. In addition, synthetic closures from foam thermoplastics have generally exhibited poor uniformity in terms of size, shape, weight, and other features important to production, marketing, and performance.

In a particular case of injection molding of foam thermoplastic closures for liquid containers, thermoplastic compositions are injected into relatively cool molds, leading tot the formation of a dense outer “skin” at the surface of the closure and a porous, foam-like interior. The composition of the closure and the structural relationship between the outer skin and porous cork of the closure may be critical to the sealing capabilities of the finished closure. Other foam thermoplastic closures have suffered problems due to wrinkling of the outer skin layer, which can produce leakage fissures between the closure and container. Other prior art closures have different sealing problems, for example, failing to quickly return to normal size after compression, such that reliable seal formation requires containers to be kept in an upright position for an extended period after insertion of the closure. Further, prior art closures are unable to significantly retain printed matter for a significant period of time.

U.S. Pat. No. 6,127,437 provides a molded closure for liquid containers comprising a thermoplastic elastomer (“TPE”) and a blowing agent that, when fitted into a liquid container, offers high resistance to oxygen permeation and produces little or no product tainting.

The molded closure can also be produced for non-liquid containers.

Such closure for liquid containers have essentially all of the desirable qualities of natural cork, and little of undesirable features; they reliably seal liquid containers immediately upon insertion.

Such molded closure is preferably molded in the shape of a cork sized to fit a wine bottle. It has substantial uniformity of size, shape and weight and is aesthetically pleasing. Its appearance is distinctive from the look of natural cork by virtue of the present invention's artificial coloring, marbled surface texture, and ability to have a symbol embossed on its surface, preferably at one or both of its ends. In addition, the closure may be readily inserted into liquid containers using standard bottling equipment, and is easily removed using a traditional corkscrew without sticking, crumbling or subsequent expansion. Because the molded closure of the invention does not expand upon removal, it may be re-inserted into the liquid container, thereby reclosing the container when it is not fully emptied. The molded closure may also be contacted with liquid contents in the container immediately after insertion, thereby removing the need for a waiting period to allow for formation of a proper seal between the molded closure and the container before the container is placed horizontally.

The molded closure or a liquid container, preferably a wine bottle, comprising a IPE and a blowing agent in a ratio suitable to provide a molded closure, is able to close a bottle of wine, thereby preventing spillage, and able to prevent passage of oxygen from the atmosphere to the wine, while simultaneously not substantially absorbing oxygen from the wine or the air space within the wine bottle between the molded closure and the wine. The molded closure has the ability to be removed with a corkscrew without substantial expansion, crumbling or disintegration (such expansion, crumbling or disintegration either causes the wine to become generally unpalatable and/or render the molded closure unusable).

The molded closure also has the ability to be used over and extended period (suitable for the wine to properly age to reach an appropriate drinkability, which can be about two years or more), and the ability to resist salvation in alcohol, acid or base, thereby keeping the wine free form tainting. The molded closure can further comprise one or more of a lubricant, a coloring agent, a filler, or other additives that can improve the performance and/or producibility of the closures.

The drawback of these know stoppers made of synthetic cork material is however that their printability is far from satisfactory, even with pre-treatment steps as envisaged in said U.S. Pat. No. 6,127,437. These pre-treatment steps involve high intensity electromagnetic radiation, such as corona-pre-treatment, which are standard treatment in printing industry.

### SUMMARY OF THE INVENTION

It is the purpose of the present invention to provide a new method to treat objects of cork material which considerably improves their printability as compared with methods known before in the art.

This purpose, and others as set out herebelow, are achieved by the method according to this invention for preparing the surface of objects made of cork material for their subsequent printing, in which method said objects are subjected to at least one low pressure plasma treatment step.

According to a further feature of the invention, the cork material is selected from natural cork and synthetic cork.

The cork material is preferably synthetic cork, and most preferably comprises thermoplastic elastomer and/or styrene bloc copolymer, but may also suitably be selected from natural colored cork black cork.

### DETAILED DESCRIPTION OF THE PREFERRED EMBODIMENTS

The thermoplastic elastomer and/or styrene bloc copolymer, synthetic cork material, is, most suitably formed from a composition comprising one or more TPEs and one or more blowing agents. The durometer measurement of the molded closure, which is effectively an indirect measure of the hardness of the TPE used to make the molded closure, is generally from about 65 A to about 90 A, typically from about 70 A to about 85 A, and preferably from about 71 A or 75 A to about 80 A. The TPE generally comprises from about 70% to about 97% of the composition, typically from about 80% to about 95% and preferably from about 90% to about 95% of the composition (unless otherwise noted, all percentages herein are by volume). The TPE also has a suitable force of compression for improved sealability and long service life. The TPE is easily processed, enabling fast cycle times and high production rates. Further, selected TPEs meet FDA requirements for indirect food additives intended to come in contact with food.

The TPE preferably comprises a styrenic block copolymer, and further preferably comprises one or more of a styrene-ethylene-butylene-styrene copolymer (“SEBS”) a styrene-ethylene-butylene copolymer, a styrene-butadiene-styrene copolymer, a styrene-butadiene copolymer, a styrene-isoprene-styrene copolymer, a styrene-isoprene copolymer, a styrene-ethylene-propylene-styrene copolymer, and a styrene-ethylene-propylene copolymer. The inclusion of a styrenic block copolymer, and particularly SEBS, is especially advantageous in the molded closure (especially when the molded closure is a wine cork) because such copolymers provide superior properties to the molded closure when compared to other TPEs. In a still further preferred embodiment, the styrenic block copolymer is SEBs. Such SEBS copolymers are resistant to water, bases, acids and alcohol.

The blowing agent generally comprises greater than 1% of the composition, and typically comprises a range that includes at least about 1.3%, 1.5% or 2.0% of the composition, and less than about 9.0%, 5.0%, 4.0% or 3.0% of the composition. Preferably, the blowing agent comprises from about 1.3% to about 3% of the composition, typically from about 1.5% to about 2.5%, and preferably about 2% of the composition. The precise amount of blowing agent used may be determined by one skilled in the art of taking into account the precise polymer, blowing agent, and other ingredients used, as well as the molding conditions.

According to a further preferred feature of the method according to the invention, the low pressure plasma used comprises a gas or gas mixture selected from O₂, N₂, NOₓ, NH₃, Ar, He, Ne, CO, CO₂, SO₂, SO₃, CF₄ and SF₆.

The pressure of the low pressure plasma ranges preferably from 0.01 to 5 mbar, and the low pressure plasma is preferably ignited by means of a power supply operating in the KHz, MHz or GHz range.

The method includes the possibility to optimize the treatment to the degree of contamination (for instance by mould release agents and/or additives on the surface of the objects) by dividing the treatment in different treatment steps which are run after each other.

The method can thus also be adapted to the pretreatment of the different materials envisaged.

Different procedures therefor are the following:

As a cleaning procedure:

A first plasma treatment step with one or more gases from those, listed above, has mainly the task to remove contaminations from the surface like mould release, additives, oils, . . . In this step preferably a gas mixture is used, where at least on gas contains oxygen. Additional gases out of the list can be used to increase the cleaning speed.

The gases or gas mixture can be fitted to the used compounds and additives to ensure for each compound the desired effectiveness of treatment.

As a modification procedure:

In this procedure a gas is used to chemically modify the surface of the corks in a way to obtain an optimal surface tension and functional groups to achieve the best possible adhesion to the used printing links.

This step is done preferably with a oxygen or nitrogen containing gas or mixture.

Said steps can be used separately as single step process or in a multistep process of at least 2 combined treatment steps, where the first step is typically a cleaning procedure and the second step a modification procedure. The multistep procedures can also be a combination of more than 2 treatment steps.

According to still another preferred feature of the invention, the plasma treatment step(s) is (are) carried out at least several hours, and even several days, before printing the objects made of cork material.

The plasma treatment can thus separate the pretreatment step of the corks from the printing step, both in time and in distance, which constitutes a considerable advantage from the point of view of logistics.

In accordance with a specific embodiment of the invention the objects are preferably tumble treated as bulk goods in batches of at least 100 pieces/batch, most preferably in batches of minimum 1000 pieces.

The described plasma treatment increases the surface energy to a level, which is satisfying to achieve adhesion to the typical used inks. This level is measured by means of specified test liquids with defined surface tensions.

The treatment surface has a surface dyne level of at least 50 dynes, when a test liquid with 50 dynes surface tension can be applied as a closed film. The used test liquid can i.e. be a mixture of alcohol and water or other suitable mixtures of solvents.

According to preferred feature of the invention the plasma treatment step(s) is (are) applied so as to reach a surface dyne level of at least 50 dynes, which is at least stable for more than 2 weeks.

In a preferred embodiment of the method according to the invention, the objects made of synthetic cork material are suitably introduced in an area in which, successively,

the pressure is reduced to less than 0,1 mbar, a gas or gas mixture selected from O₂, N₂, NOₓ, NH₃, Ar, He, Ne, CO, CO₂, SO₂, SO₃, CF₄ and SF₆ is introduced at a pressure ranging up to 5 mbar,

the gas or gas mixture is ignited to form a plasma using a power supply working in the KHz, MHz or GHz range,

whereas the objects made of cork material are kept tumbling in the plasma and treated for several minutes so as to reach a surface dyne level of at least 50 dynes.

A second or more steps can be added with different treatment parameters to obtain the optimal treatment conditions for each material.

We claim:

1. Method for preparing the surface of objects made of cork material for printing, in which said objects are subjected to at least one low pressure plasma treatment step.

2. Method according to claim 1, in which the cork material is selected from natural cork and synthetic cork.

3. Method according to claim 1, in which the cork material is selected from synthetic cork.

4. Method according to claim 4, in which the synthetic cork material comprises thermoplastic elastomer and/or styrene bloc copolymer.

5. Method according to claim 1, in which the cork material is selected from natural colored cork or black cork.

6. Method according to claim 1, in which the low pressure plasma uses a gas or gas mixture selected from O₂, N₂, NOₓ, NH₃, Ar, He, Ne, CO, CO₂, SO₂, SO₃, CF₄ and SF₆.

7. Method according to claim 1, in which the pressure of the low pressure plasma ranges from 0.01 to 5 mbar.

8. Method according to claim 1, in which the low pressure plasma is ignited by means of a power supply operating in the KHz, MHz or GHz range.

9. Method according to claim 1, in which the plasma treatment step(s) is (are) carried out at least several hours before printing the objects made of cork material.

10. Method according to claim 1, in which the plasma treatment step(s) is (are) carried out several days before printing the objects made of synthetic cork material.

11. Method according to claim 1, in which the objects are tumble treated as bulk goods in batches of at least 100 pieces/batch.

12. Method according to claim 1, in which the plasma treatment step(s) is (are) applied so as to reach a surface dyne level of at least 50 dynes.

13. Method according to claim 1, in which the objects made of synthetic cork material are provided in an area in which, successively, the pressure is reduced to less than 0,1 mbar, a gas or gas mixture selected from O₂, N₂, NOₓ, NH₃, Ar, He, Ne, CO, CO₂, SO₂, SO₃, CF₄ and SF₆ is introduced at a pressure ranging up to 5 mbar, and the gas or gas mixture is ignited to form a plasma using a power supply working in the KHz, MHz or GHz range, whereas the objects made of cork material are kept tumbling in the plasma atmosphere and treated for several minutes so as to reach a surface dyne level of at least 50 dynes.

14. Method according to claim 13, in which the synthetic cork material comprises thermoplastic elastomer and/or styrene bloc copolymer.
